(19) United States
(12) Patent Application Publication
(10) Pub. No.: US 2007/0037618 A1
(43) Pub. Date: Feb. 15, 2007

(54) Mobile terminal having an additional keypad

(76) Inventor: Kyung Joon Lee, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/284,626

(22) Filed: Nov. 21, 2005

(30) Foreign Application Priority Data
Aug. 10, 2005 (KR) 10-2005-0073051

(51) Int. Cl. H04M 1/00

(52) U.S. Cl. 455/575.4

(57) ABSTRACT

Disclosed is a mobile terminal including a terminal body; a display portion movably mounted on the terminal body; and a keyboard portion provided to be slidable on the bottom of the terminal body and selectively exposing an auxiliary keypad. Also, disclosed is a mobile terminal including a body portion; a display portion mounted on the body portion and having a display; a keyboard portion provided on the body portion to be situated therein or slid to be opened to the outside of the body portion; an auxiliary keypad provided on the keyboard portion; and an operating unit attached to the terminal body and enabling the keyboard portion to be opened via an operation button, but, when the display portion is opened, locking the closed keyboard portion even in the case the operation button is pressed. Due to the auxiliary keypad, it is possible to improve the effectiveness in creating a text message and make a game more interesting. Also, in the case the auxiliary keypad is not used to make a call, a locking function is also provided to prevent opening of the keypad to the outside, thereby not interfering with the call.

### CROSS-REFERENCE TO RELATED APPLICATIONS

This application claims priority under 35 U.S.C. §119(a) from Republic of Korea Patent Application No. 10-2005-0073051, filed on Aug. 10, 2005 in the Korean Intellectual Property Office, the disclosure of which is incorporated by reference herein in its entity.

### BACKGROUND OF THE INVENTION

1. Field of the Invention

The present invention relates to a mobile terminal, and more particularly, to a mobile terminal in which an auxiliary keypad is provided to improve the effectiveness in creating a text message and making a game more interesting. In the case the auxiliary keypad is not used, such as when making a call, a locking function is also provided to conceal the keypad from the outside, thereby not interfering with the call.

2. Description of the Related Art

Generally, a mobile terminal is a type of communication equipment that a user can conveniently carry and make a call to another person from different places. The mobile terminal is a concept which includes a PDA (Personal Digital Assistant), a cellular phone, a PCS (Personal Communication Service) phone, a Hand-Held PC, a CDMA-2000 (Code Division Multiple Access 1×, 3×) phone, a WCDMA (Wideband CDMA) phone, a Dual Band/Dual Mode phone, a GSM (Global Standard for Mobile) phone, an MBS (Mobile Broadband System) phone, a notebook computer, and the like.

Since the main characteristic of a mobile terminal is to enable a user to carry the mobile terminal along with the user, a small-sized mobile terminal is preferred. Also, a mobile terminal having a special design or various functions is preferred by a significant number of users. Accordingly, mobile phones which are currently being released are products having functions to enable a user to listen to music, enjoy a movie, create and send a text message, play a game, not to mention the original function of making a call.

Mobile terminal as above can be generally classified as a flip method, a folder method, and a sliding method. The flip method means a method of generally providing a display portion like an LCD (Liquid Crystal Display) and a key input portion on the same body and uses a cover connected to the lower portion via a hinge which protects the key input portion when closed, or is used to receive or make a call when opened. Also, the folder method is a method of connecting two pieces of folder parts via a hinge to be opened and closed, and providing a main display portion and a key input portion on the two facing surfaces. Finally, the sliding method means a method of two overlapping pieces of sliding parts and providing a display portion and a key input portion on each sliding part facing the same direction. Generally, the sliding method can expose the display portion or the key input portion, which is concealed by the top portion, by sliding the top sliding part.

The mobile terminal of each method as described above includes button-type keys through which letters and numbers can be inputted and navigation keys on the key input portion. The mobile terminal of the sliding method having the general key input portion as above is illustrated in FIG. 1. As illustrated in FIG. 1, the mobile terminal includes a body portion 20 including a camera apparatus 10, a display portion 30 provided with a display 35 and slidably attached to the body portion 20, and a key input portion 40 for inputting letters and numbers.

The key input portion 40 includes input keys 41, navigation keys 42, and function keys 43. The input keys 41 are provided on the body portion 20 and in the shape of a button to enable a user to input a number and a letter. The navigation keys 42 are provided in a radial direction to enable the user to selectively press a key, and the function keys 43 are provided around the navigation keys 42. The input keys 41 are constructed such that the user may select and input letters by pressing one key several times when the user creates a text message. For example, in case of creating a text message in English, if each of the 26 alphabet letters is allocated one key, 26 buttons are needed. However, because of a limited installation space, a plurality of letters is allocated to one button and thereby, a user is able to select and input all alphabet letters only with about 12 input keys 41. Generally, the user has to select a letter by pressing one key several times. Thus, there is a problem that creating a text message is inconvenient and takes time.

Namely, until now a user has had to input a number of numbers or letters with the limited number of input keys in the mobile terminal. Thus, a plurality of alphabet letters or Hangul consonants and vowels, or numbers is allocated to one input key. As a matter of fact, while the user uses the mobile terminal, a letter for the English alphabet, Korean alphabet, Chinese alphabet or some other language's alphabet, or a number is selected in accordance with an input key, and the number of times that input key is pressed. Thus, it has been very inconvenient for the user to use the mobile terminal constructed as above.

Also, while the functions of mobile terminals are being diversified and users playing a game via the mobile terminals are also increasing, it is hard to say that the input keys 41 sufficiently play their role as input buttons for a game. To play a game, direction keys capable of moving an avatar in all directions or a plurality of operation keys capable of performing special operations are needed as input buttons. However, there is a problem that the space of a mobile terminal is insufficient to provide all those buttons.

In addition to the input keys 41, the navigation keys 42 are provided. However, all input buttons desired by a user may not be provided because the installation space is small. If input buttons desired by the user are all provided by increasing the number of buttons, the area of one button becomes too small. Thus, the user may feel inconvenience in operating the buttons and also may have difficulty in finding the proper button because of special keys for a game, or when the user wants to make a call or create a text message. Furthermore, if too many buttons are provided, it is aesthetically wanting. Also, there is a problem that the size of the mobile terminal may become cumbersome. Thus, it is not a preferable solution.

### SUMMARY OF THE INVENTION

The present invention is conceived to solve the problems as described above. Thus, the present invention provides a mobile terminal which can improve the effectiveness in creating a text message and make a game more interesting by providing an auxiliary keypad for the SMS message or the game.

The present invention also provides a mobile terminal in which an auxiliary keypad is not used such as when making a call, and a locking function is also provided to not open the keypad to the outside, thereby not interfering with the call.

The present invention also provides a mobile terminal with a convenient keypad having a compact external appearance because an auxiliary keypad can be closed.

To achieve the above objectives of the present invention, according to an aspect of the present invention, a mobile terminal includes a terminal body, a display portion movably mounted on the terminal body; and a keyboard portion provided to be slidable on the bottom of the terminal body and selectively exposing an auxiliary keypad. The keyboard portion may be constructed in plural, and the auxiliary keypad may be variously formed to be an English, Chinese or Korean keyboard to create a text message, or directional keys or operational keys for a game. The present invention is not limited to a cell phone formed with the sliding method, however, and may be constructed to include a body portion and a display portion slidably provided on the body portion and displaying visual information. Also, the display portion may be constructed to slide in the lengthwise direction of the body portion or to horizontally slide in the widthwise direction of the body portion.

Also, the keyboard portion may be constructed to be automatically opened by using an operation button. Thus, an operating unit including the operation button includes a moving guide attached to the keyboard portion to be movable in accordance with the pushing of the operation button; a guide groove concavely formed on the rear of the terminal body to guide the moving guide; and an elastic body connected to the moving guide to move the same by an elastic force.

Also, according to another aspect of the present invention, a mobile terminal includes a body portion; a display portion mounted on the body portion and having a display; a keyboard portion provided on the body portion to be closed therein or slid to be opened to the outside of the body portion; an auxiliary keypad provided on the keyboard portion; and an operating unit attached to the terminal body and enabling the keyboard portion to be opened via an operation button, but, when the display portion is opened, locking the keyboard portion in the closed position even in the case the operation button is pressed.

The operating unit includes an operation button disposed on one side of the terminal body to enable a user to press; a moving guide attached to the keyboard portion to be movable in accordance with the pushing of the operation button; a guide groove concavely formed on the rear of the terminal body to guide the moving guide; an elastic body connected to the moving guide to move the same by an elastic force; a rotating block capable of rotating and protruded on the lower part of the terminal body; and a combination block protruded on the lower part of the display portion and rotating the rotating block in the case the display portion is open and maintaining a certain interval with the rotating block in the case the display portion is folded closed.

### BRIEF DESCRIPTION OF THE DRAWINGS

The above and other features and advantages of the present invention will become more apparent by describing in detail exemplary embodiments thereof with reference to the attached drawings in which:

FIG. 1 is a front view illustrating a mobile terminal provided with a general key input portion;

FIG. 2 is a perspective view illustrating the rear of a mobile terminal according to a first embodiment of the present invention;

FIG. 3 is a perspective view illustrating the state where a display portion of the mobile terminal according to the first embodiment is opened;

FIG. 4 is a perspective view illustrating the state where first and second keyboard portions of the mobile terminal according to the first embodiment of the present invention are opened;

FIG. 5 is an exploded perspective view of the mobile terminal according to the first embodiment of the present invention;

FIG. 6 is a cross-sectional view of the mobile terminal according to the first embodiment;

FIG. 7 is a cross-sectional view illustrating an operating unit of a mobile terminal according to a second embodiment of the present invention;

FIG. 8 is a perspective view of a mobile terminal according to a third embodiment of the present invention;

FIG. 9 is a perspective view illustrating another modified example of the third embodiment;

FIG. 10 is an exploded perspective view according to a fourth embodiment of the present invention;

FIG. 11 is an exploded perspective view of an operating unit according to the fourth embodiment of the present invention;

FIG. 12 is a perspective view illustrating the appearance of the operating unit in the case a display portion according to the fourth embodiment of the present invention is closed;

FIG. 13 is a cross-sectional view illustrating along A-A′ line of FIG. 12;

FIG. 14 is a perspective view illustrating the operating unit when the display portion according to the fourth embodiment of the present invention is opened; and

FIG. 15 is a cross-sectional view illustrating along B-B′ line of FIG. 14.

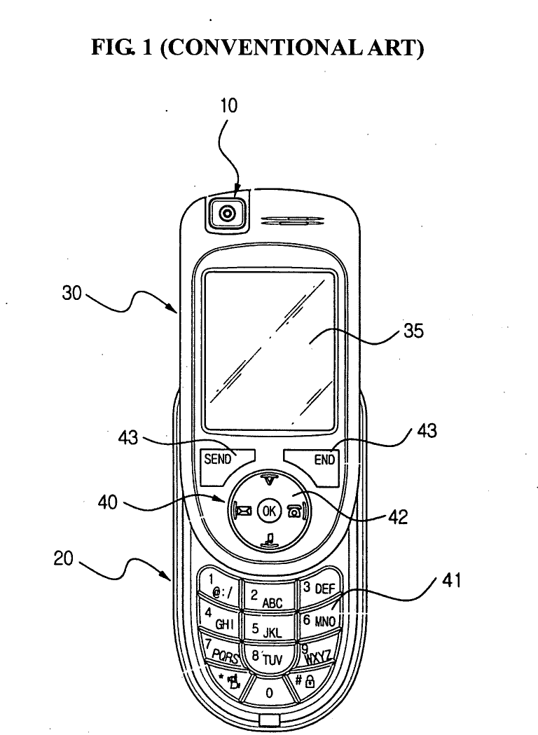

### DETAILED DESCRIPTION OF THE INVENTION

Hereinafter, exemplary embodiments of the present invention will be described in detail with reference to the accompanying drawings, but the present invention is not limited thereto or restricted thereby. Also, a slide-type mobile phone is described in the present invention for convenience of description, but the present invention is not limited thereto and applicable to a folder-type mobile phone.

### Embodiment 1

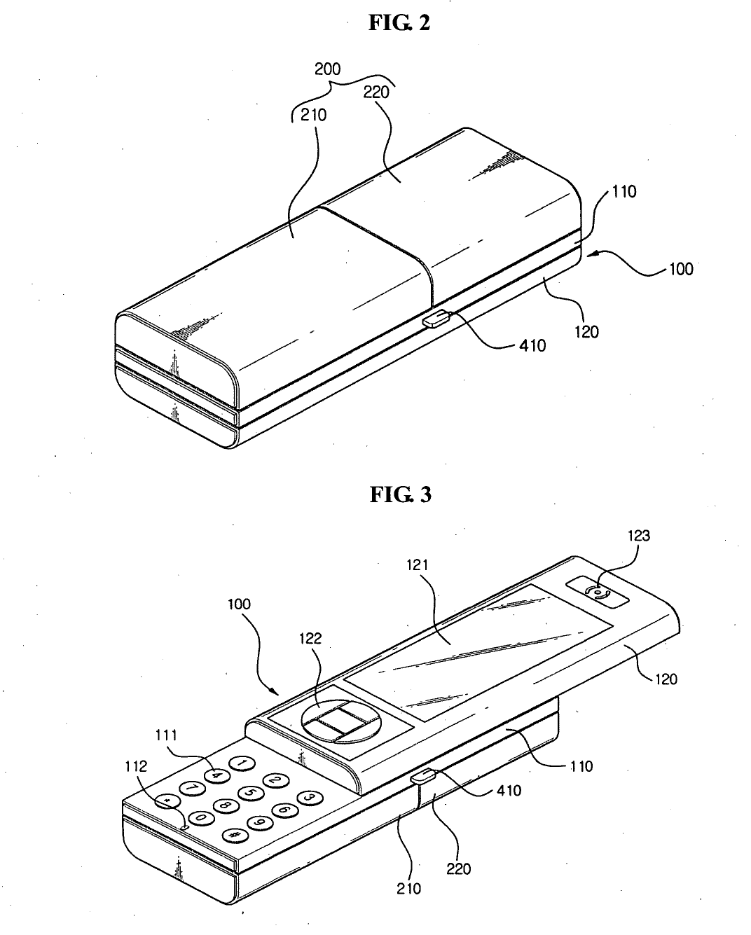

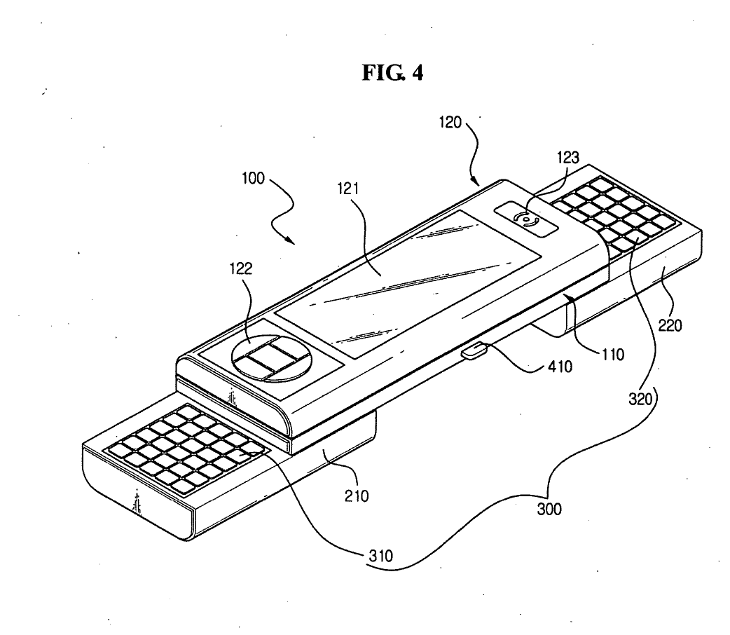

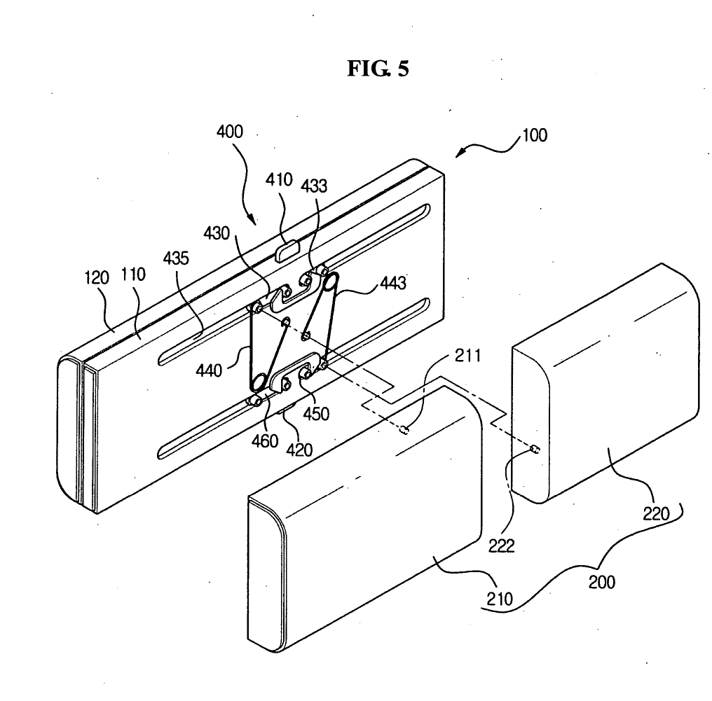

FIG. 2 is a perspective view illustrating the rear of a mobile terminal according to a first embodiment of the present invention, FIG. 3 is a perspective view illustrating the state where a display portion of the mobile terminal according to the first embodiment is opened, and FIG. 4 is a perspective view illustrating the state where first and second keyboard portions of the mobile terminal according to the first embodiment of the present invention are opened.

As illustrated in the figures, the mobile terminal of the present invention includes a terminal body 100, a keyboard portion 200, and an auxiliary keypad 300.

The terminal body 100 includes a body portion 110 embedded with a communicable circuit member and a display portion 120 provided to be slidable up and down. The body portion 110 is provided with a plurality of input keys 111 in the shape of a button to enable a user to input a number and a letter. A microphone 112 capable of receiving an audio signal is provided on one side of the body portion 110. Also, although not illustrated in the figures, a battery supplying power is provided. An operation button 410 capable of opening a first keyboard portion 210 from the keyboard portion 200 is provided on the side of the body portion 110. Another operation button capable of opening a second keyboard portion 220 may be provided on the opposite side to operation button 410. A display 121 displaying visual information is provided on the display portion 120, a speaker 123 outputting audio information is provided on the upper part of the display portion 120, and auxiliary keys 122, called navigation keys or multi-keys, are provided on the lower part of the display portion 120.

The keyboard portion 200, as illustrated in FIG. 2, includes the first keyboard portion 210 and the second keyboard portion 220, as shown in FIG. 4, which are attached on the bottom of the body portion 110 and slide so as to be opened in an opposite direction to each other. The first and second keyboard portions 210 and 220 operate via the operation button 410 provided on the side of the body portion 110, and will be described in detail later.

The auxiliary keypad 300 includes a first auxiliary keypad 310 provided on the first keyboard portion 210 and a second auxiliary keypad 320 provided on the second keyboard portion 220. The first and second auxiliary keypads 310 and 320 are provided with letter keys necessary to create an SMS message. At this time, an alphabetic keyboard may be provided on the first auxiliary keypad 310 and a Hangul keyboard may be provided on the second auxiliary keypad 320. Also, the locations of the alphabet and Hangul keyboards may be exchanged.

More specifically, an English keyboard formed in a “qwerty” letter arrangement may be provided on the first auxiliary keypad 310 and a Korean or Chinese keyboard may be, provided on the second auxiliary keypad 320. Or, an English or Korean keyboard may be provided on the first auxiliary keypad 310, and numbers and special characters may be provided on the second auxiliary keypad 320.

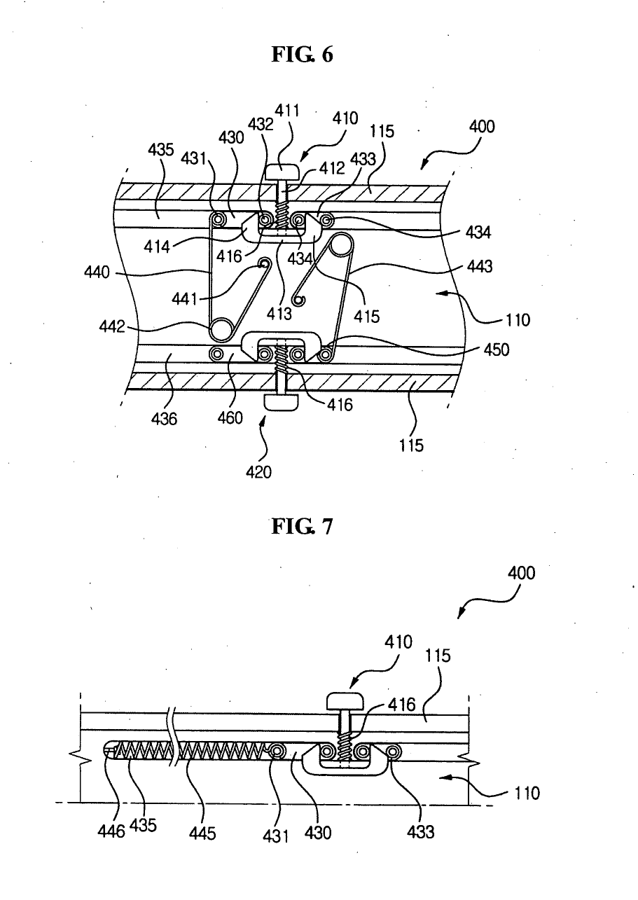

FIGS. 5 and 6 are views for explaining how a keyboard portion is opened by an operation button. FIG. 5 is an exploded perspective view of the mobile terminal according to the first embodiment of the present invention, and FIG. 6 is a cross-sectional view of the mobile terminal according to the first embodiment.

As illustrated in the figures, the present mobile terminal includes an operating unit 400 automatically opening the keyboard portions 210 and/or 220 closed into the terminal body 100 via operation buttons 410 and/or 420. The configuration of the operating unit 400 is divided into the first operation button 410 opening the first keyboard portion 210 and into the second operation button 420 opening the second keyboard portion 220 as necessary. First, the configuration of opening the first keyboard portion 210 will be described below.

The operating unit 400 includes a first operation button 410 disposed on one side of the body portion 110 to enable a user to press; a first moving guide 430 attached to the first keyboard portion 210 to be movable in accordance with the pushing of the first operation button 410; a first guide groove 435 concavely formed on the rear of the body portion 110 to guide the first moving guide 430; and a first elastic body 440 connected to the first moving guide 430 to move the same by an elastic force.

The first operation button 410 is inversed “T”-shaped, includes a pressing portion 411 extended on one end thereof to help a user to press the first operation button 410; a vertical extension portion 412 vertically extended from the pressing portion 411 to pass through a body case 115; a horizontal extension portion 413 horizontally extended from the center of the end of the vertical extension portion 412 in both directions; and first and second hooks 414 and 415 curved toward the body case 115 at both ends of the horizontal extension portion 413.

The pressing portion 411 is formed to be round and constructed to enable a user to press easily. The vertical extension portion 412 is provided with an elastic spring 416 in the body case 115. It is preferable that the elastic spring 416 enables the pressing portion 411 of the operation button 410 to be protruded to the outside again after the user releases the same. For this, the elastic spring 416 is initially provided in a slightly compressed state.

The outer surface shape of the first and second hooks 414 and 415 is formed to be inclined. Also, the outer surface shape of the first and second hooks 414 and 415 may be formed to be curved to have a certain curvature. The first hook 414 is provided to hook a protrusion 432 of the first moving guide 430, which will be described later. Also, the second hook 415 may further include a rectilinear first fixing guide 433 capable of going in and out from the center of the two guide protrusions 434 in accordance with the pressing of the operation button. Guide protrusions 434 are formed on both ends of the first fixing guide 433.

The first moving guide 430 is formed rectilinearly and an anchor portion 431 to which the first elastic body 440 is attached is formed on one end of the first moving guide 430 and a protrusion 432 capable of being hooked by the first hook 414 of the first operation button 410 is formed on the other end of the first moving guide 430. Also, the anchor portion 431 is joined with a first keyboard portion combining portion 211 protruded in the first keyboard portion 210 to enable the first keyboard portion 210 to interconnect with the first moving guide 430.

The width of the first guide groove 435 is formed wider than that of the first moving guide 430, thereby not impeding the movement of the first moving guide 430. Also, the length of the first guide groove 435 has to be extended long enough to fully open the auxiliary keypad of the first keyboard portion 210 connected to the first moving guide 430 to the outside, when the first moving guide 430 reaches the end of the first guide groove 435.

One end of the first elastic body 440 is attached to an anchoring projection 441, formed on the bottom of the body portion 110, and the other end thereof is fixed to the anchor portion 431 of the first moving guide 430. It is preferable that the first elastic body 440 is a torsion spring, which is “L”-shaped, and forms a layered coil 442 by repeated winding to enhance its elastic force in its middle.

The configuration of opening the second keyboard portion 220 from the operating unit 400 will be described below. The operating unit 400 includes a second operation button 420 disposed on the body portion 110 opposite to the first operation button 410 to enable a user to press; a second moving guide 450 attached to the second keyboard portion 220 to be movable in accordance with the pushing of the second operation button 420; a second guide groove 436 concavely formed on the rear of the body portion 110 to guide the second moving guide 450; and a second elastic body 443 connected to the second moving guide 450 to move the same by an elastic force. Also, a second fixing guide 460 is included in the location and configuration corresponding to the first fixing guide 433.

The second operation button 420, the second moving guide 450, the second fixing guide 460, the second guide groove 436, a second keyboard combining portion 222, and the second elastic body 443 are provided to correspond to the first operation button 410, the first moving guide 430, the first fixing guide 433, the first guide groove 435, the first keyboard combining portion 211, and the first elastic body 440, respectively. Also, the configuration thereof is constructed to be same. Thus, the detailed description related thereto will be omitted.

Hereinafter, operations and effects according to the first embodiment of the present invention will be described.

A user presses the pressing portion 411 of the first operation button 410 to draw the first keyboard portion 210 as necessary. While the operation button 410 is being pressed, the protrusion 432 hooked by the first hook 414 of the operation button 410 is being released and the first moving guide 430 moves by an elastic force of the first elastic body 440. As the first moving guide 430 moves, the first keyboard portion 210 attached thereto also moves to be opened to the outside of the body portion 110. The first moving guide 430 moves to the end portion of the first guide groove 435, and the first keyboard portion 210 connected thereto is also opened. In this manner, a user can use an auxiliary keypad provided on the first keyboard portion 210.

The user pushes the first keyboard portion 210 toward the body portion 110 to close the first keyboard portion 210. At this time, the first moving guide 430 connected to the first keyboard portion 210 moves, and the protrusion 432 formed on the other end of the first moving guide 430 goes over the first hook 414, since the outer surface shape of the first hook 414 is inclined, to move to the inside of the first hook 414. Accordingly, the protrusion 432 of the first moving guide 430 is again locked via the first hook 414, and the first keyboard portion 210 connected to the first moving guide 430 is closed into the body portion 110. At this time, the vertical extension portion 412 of the operation button 410 is provided with the elastic spring 416 in the body case 115, which enables the operation button 410 to be returned to the previous state which is protruded to the outside.

Also, the user presses the second operation button 420 to open the second keyboard portion 220, and the procedures thereof are the same to those of the first operation button 410 and also, the procedures of closing the second keyboard portion 220 are the same to those of the first keyboard portion 210. Also, the user may select and open only the first or the second keyboard portions 210 and 220 which have the auxiliary keypads the user desires. The user may press both the first operation button 410 and the second operation button 420, thereby opening both the first and the second keyboard portions 210 and 220.

Accordingly, since a user can be provided with an auxiliary keypad as necessary for creating a text message, there is an effect that it is possible to improve the effectiveness in creating a text message. Also, in the case the auxiliary keypad is not used, an auxiliary keypad may be closed. Thus, when a user makes a call, the call is not interfered with. Also, a mobile terminal looks aesthetically pleasing and it is easy to use since it is possible to open and close an auxiliary keypad.

### Embodiment 2

FIG. 7 is a cross-sectional view illustrating an operating unit of a mobile terminal according to a second embodiment of the present invention. In describing the second embodiment, identical reference numbers are assigned to portions identical to the portions in the first embodiment, and description related thereto will be omitted.

As illustrated in FIG. 7, a third elastic body 445 connected to the first moving guide 430 and moving the same by an elastic force is also included. The third elastic body 445 is an elastic spring disposed along the guide groove 435, and one end of the third elastic body 445 is connected to an anchor portion 431 of the first moving guide 430 and the other end of the third elastic body 445 is attached to a projection 446 formed on the end portion of the guide groove 435. It is preferable that the third elastic body 445 is initially provided in a tense state to pull the first moving guide 430.

The first moving guide 430 moves by an elastic force of the third elastic body 445 and as the first moving guide 430 moves, the first keyboard portion 210 attached thereto is also opened to the outside of the body portion 110. This is the same as the first embodiment. At this time, the first moving guide 430 may collide into the projection 446 formed on the end of the guide groove 435. Thus, it is preferable that the projection 446 is formed of an elastic material such as rubber in order to prevent noise and damage to the respective elements. Similarly, an elastic body capable of opening the second keyboard portion 220 may be configured. Thus, the “L”-shaped first elastic body 440, which has been described in the first embodiment, may be used to open the first keyboard portion 210, and the third elastic body 445, which has been described in the second embodiment, may be used to draw the second keyboard portion 220.

### Embodiment 3

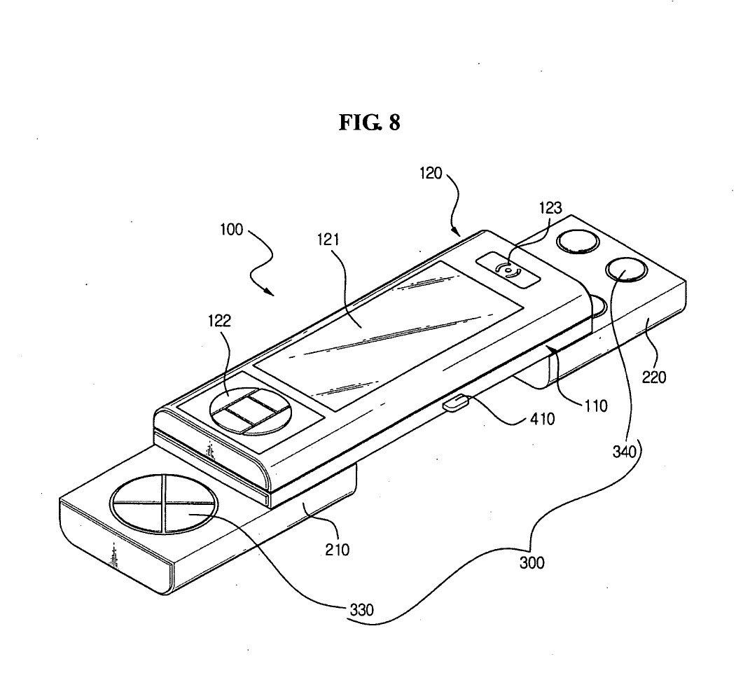

FIG. 8 is a perspective view of a mobile terminal according to a third embodiment of the present invention, in which a game keyboard may be provided on the auxiliary keyboard 300. As illustrated in FIG. 8, direction keys may be provided on the first auxiliary keypad 330 to control the movement of an avatar in a game, and a plurality of operation keys may be provided on the second auxiliary keypad 340 at a proper interval so as not to interfere with each other. Particularly, in the case of operation buttons, a user has to repeatedly press the operation buttons to play a game. Thus, the operation buttons need to be large and disposed to be spaced apart from each other at a certain interval. The auxiliary keypad may provide the space as above.

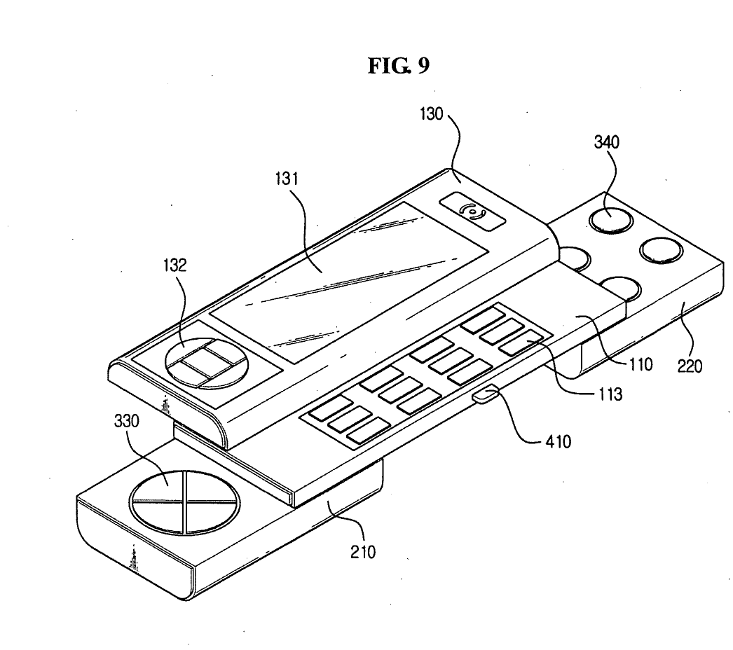

FIG. 9 is a perspective view illustrating another modified example of the third embodiment, in which the display portion 130 may be constructed to slide along the width of the body portion 110, not slide along the length of the body portion 110. In the configuration as above, the display portion 130 may slide to be opened to expose input keys 113 provided on the body portion 110 in a situation where the auxiliary keyboards 210 and 220 are opened. In this configuration, since not only the auxiliary keyboards 210 and 220 but also the input keys 113 may be used, the configuration as above is particularly suitable for a game.

Namely, direction keys and operation buttons should be provided on the auxiliary keypads 330 and 340 to enable a user to play a game. Because the features of a game require the user to click direction keys or operation buttons repeatedly and consecutively, the size of the button should be constructed to be large and in particular, a certain spatial interval should be maintained between buttons so as an adjacent button is not inadvertently pressed and causes interference with the button the user intentionally presses. Thus, the number of buttons which may be provided on the auxiliary keyboards 210 and 220 may be limited. Also, since there are various kinds of games, the number of input buttons required is also different. Accordingly, in the case an additional button apart from the auxiliary keyboards 210 and 220 is required, the input keys 113 provided on the body portion 110 may be used by opening the display portion 130.

### Embodiment 4

Briefly describing the operations of this fourth embodiment to easily understand, in the present embodiment, unlike the first embodiment, in the case the display portion is open, a keyboard portion provided with an auxiliary keypad is not opened even though a user presses an operation button. Namely, although the user opens the display portion and inadvertently presses the operation button when making a call, the keyboard portion is not opened. Thus, the keyboard portion does not interrupt the call.

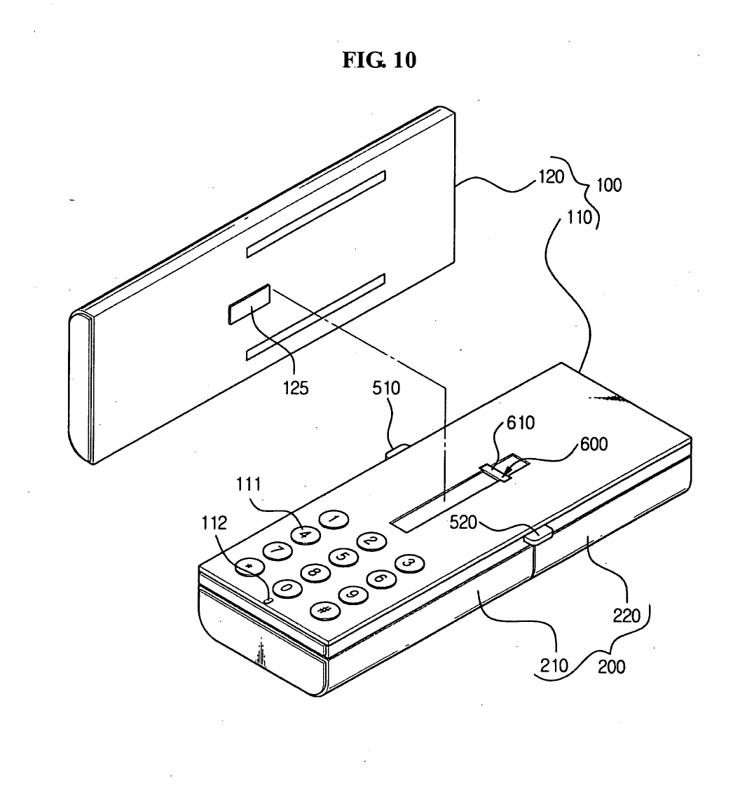

The configuration related thereto will be described in detail with reference to FIG. 10. FIG. 10 is an exploded perspective view according to the fourth embodiment of the present invention. As illustrated, the mobile terminal of the present invention includes a terminal body 100, a keyboard portion 200, an auxiliary keypad provided on the keyboard portion 200, and an operating unit 600.

The terminal body 100 includes a body portion 110 embedded with a communicable circuit member and a display portion 120 to be slidable up and down lengthwise on the body portion 110. The body portion 110 is provided with a plurality of input keys 111 in the shape of a button to enable a user to input a number and a letter. A microphone 112 capable of receiving an audio signal is provided on one side of the body portion 110. Also, although not illustrated in this figure, a battery supplying power is provided. Operation buttons 510 and 520 capable of opening the keyboard portion 200 are provided on the side of the body portion 110.

The keyboard portion 200 includes a first keyboard portion 210 and a second keyboard portion 220 which are attached to the bottom of the body portion 110 and may slide to be opened in opposite directions from each other. The first and second keyboard portions 210 and 220 open via the operation buttons 510 and 520 provided on the side of the body portion 110. As described above, what is different from the first embodiment is that the first keyboard portion 210 and the second keyboard portion 220 are not opened when the display portion 120 is opened, although a user may press the operation buttons 510 and/or 520.

Like the first embodiment, the display portion 120 may include a display displaying visual information, navigation keys provided with a speaker outputting audio information, or auxiliary keys referred to as multi-keys. Also, a combination block 125 capable of pushing a rotating block 610 to rotate when the display portion 120 is opened is formed to be protruded on the bottom of the display portion 120. The rotating block 610 will be described later.

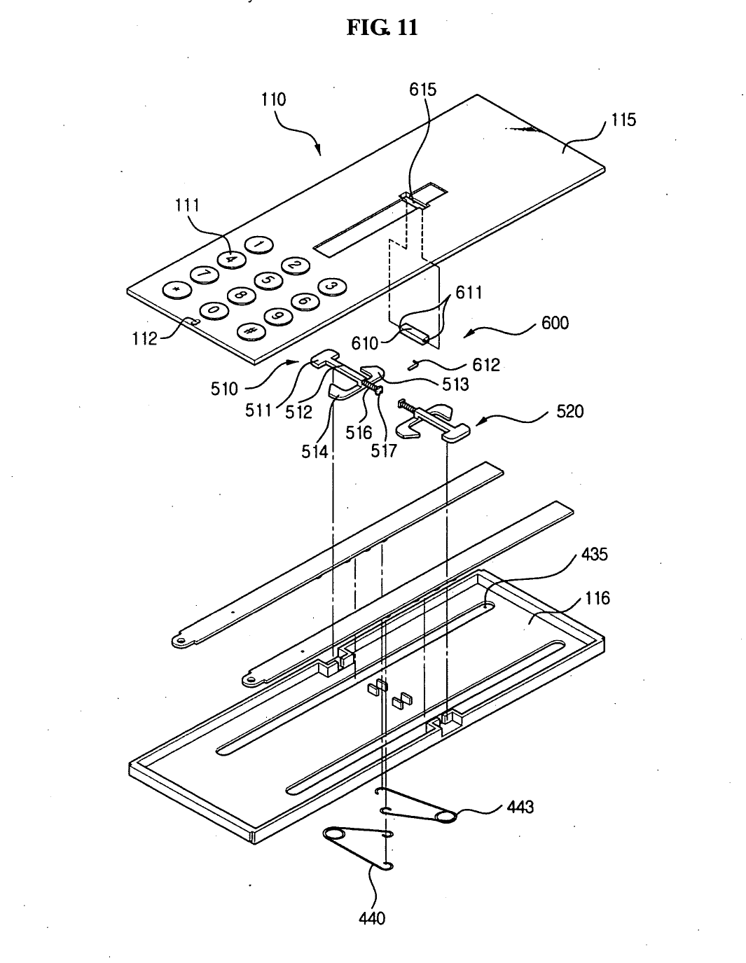

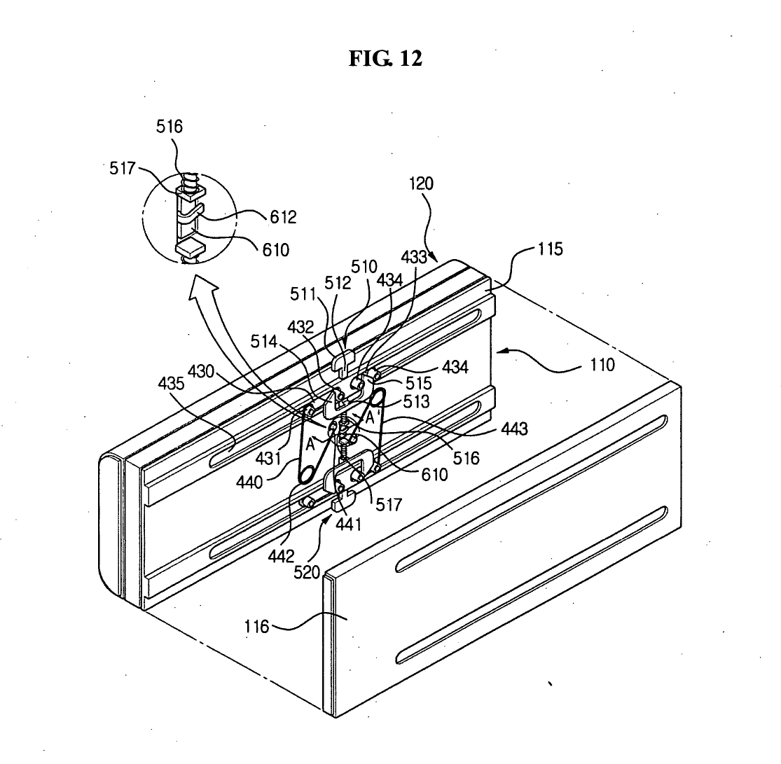

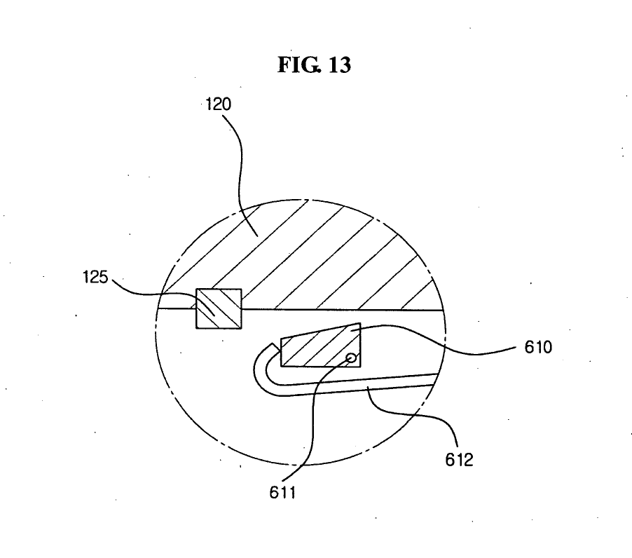

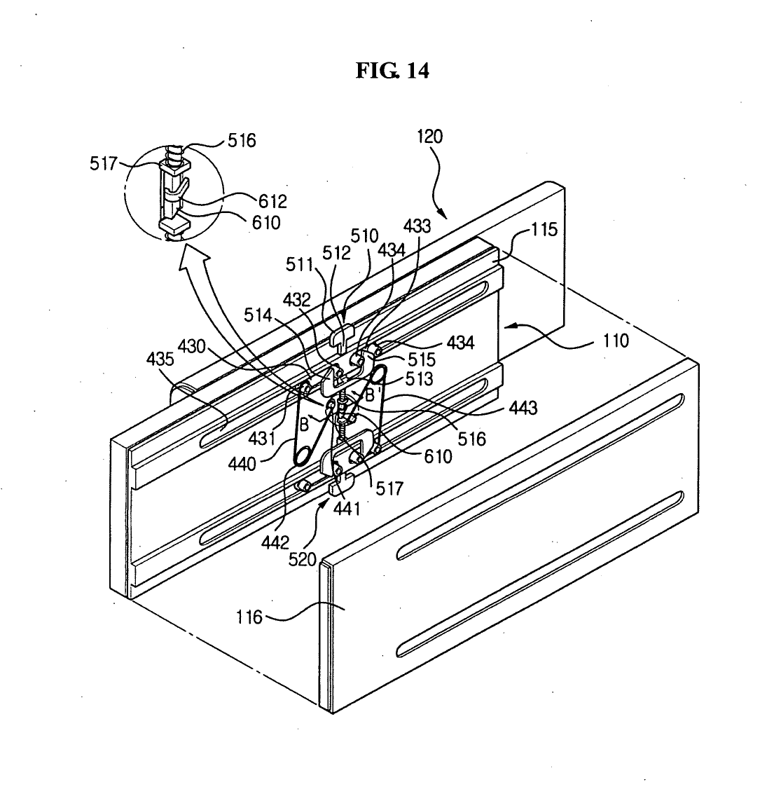

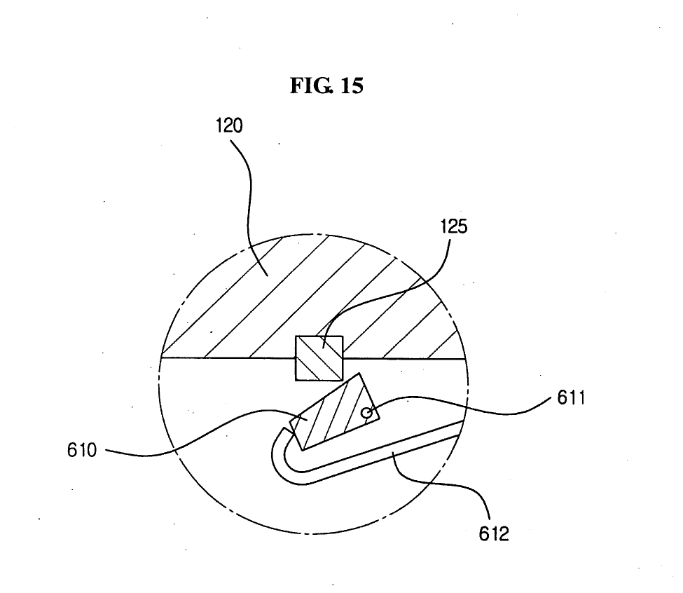

The body portion 110 includes the operating unit 600 automatically opening the keyboard portions 210 and/or 220 via the operation buttons 510 and/or 520, but not opening the keyboard portions 210 and 220 when the display portion 120 is open, although a user may press the operation buttons 510 and/or 520. The preceding will be described in detail below with reference to FIGS. 11 to 15. FIG. 11 is an exploded perspective view of an operating unit according to the fourth embodiment of the present invention, FIG. 12 is a perspective view illustrating the appearance of the operating unit in the case a display portion according to the fourth embodiment of the present invention is closed, FIG. 13 is a cross-sectional view illustrating along A-A′ line of FIG. 12, FIG. 14 is a perspective view illustrating the operating unit when the display portion according to the fourth embodiment of the present invention is opened, and FIG. 15 is a cross-sectional view illustrating along B-B′ line of FIG. 14.

The configuration of the operating unit 600 is divided into the configuration of including the first operation button 510 opening the first keyboard portion and into the configuration of including the second operation button 520 opening the second keyboard portion as necessary. First, the configuration of opening the first keyboard portion will be described below.

The operating unit 600 includes the first operation button 510 disposed on one side of the body portion 110 to enable a user to press; a first moving guide 430 attached to the first keyboard portion to be movable in accordance with the pushing of the first operation button 510; a first guide groove 435 concavely formed on the rear of the body portion 110 to guide the first moving guide 430; a first elastic body 440 connected to the first moving guide 430 to move the same by an elastic force; and the rotating block 610 preventing the movement of the first operation button 510 in the case the display portion 120 is open and not interfering with the movement of the first operation button 510 in the case the display portion 510 is closed.

The first operation button 510 is “T”-shaped, includes a pressing portion 511 extended on one end thereof to help a user to press the first operation button 510; a vertical extension portion 512 vertically extended from the pressing portion 511 to pass through a body case 115; a horizontal extension portion 513 horizontally extended from the center of one part of the vertical extension portion 512 in both directions; first and second hooks 514 and 515 curved toward the outside of the body case 115 at both ends of the horizontal extension portion 513; and a first braking portion 517 formed on the vertical extension portion 512 and extending to be formed on the end opposite to the pressing portion 511.

The pressing portion 511 is processed to be round and constructed to help a user to press easily. The vertical extension portion 512 is provided with an elastic spring 516 in the body case 115. It is preferable that the elastic spring 516 enables the pressing portion 511 of the operation button 510 to be protruded to the outside again after the user presses the same. For this, the elastic spring 516 is initially provided in a slightly compressed state.

The outer shape of the first and second hooks 514 and 515 is formed to be inclined. The first hook 514 is provided to hook a protrusion 432 of the first moving guide 430, which will be described later. Also, the second hook 515 may further include a rectilinear first fixing guide 433 capable of going in and out from the center of the two guide protrusions 434 in accordance with the pressing of the first operation button 510. Guide protrusions 434 are formed on both ends of the first fixing guide 433.

The first moving guide 430 is formed rectilinearly and an anchor portion 431 to which the first elastic body 440 is attached to is formed on one end of the first moving guide 430 and a protrusion 432 capable of being hooked by the first hook 514 of the first operation button 510 is formed on the other end of the first moving guide 430. Also, the anchor portion 431 is joined with a first keyboard portion combining portion (not illustrated) protruded in the first keyboard portion to enable the first keyboard portion to interconnect with the first moving guide 430. This is the same as the first embodiment.

The width of the first guide groove 435 is formed a slightly wider than that of the first moving guide 430, thereby not interfering with the movement of the first moving guide 430. Also, the length of the first guide groove 435 has to be extended long enough to fully open the auxiliary keypad of the first keyboard portion connected to the first moving guide 430, when the first moving guide 430 reaches the end of the first guide groove 435.

One end of the first elastic body 440 is attached to an anchoring projection 441 formed on the bottom of the body portion 110 and the other end thereof is attached to the anchoring portion 431 of the first moving guide 430. It is preferable that the first elastic body 440 is a torsion spring, which is “L”-shaped, and forms a layered coil 442 by repeated winding to enhance its elastic force in its middle.

The rotating block 610 is in the shape of a hexahedron and one side thereof is formed to be inclined. Also, the rotating block 610 is constructed to be rotatable around an axial projection 611 which is formed on both sides, and a leaf spring 612 is connected to the opposite side of the rotating block 610 from the axial projection 611 to give the force of restitution. The rotating block 610 is disposed between the first operation button 510 and the second operation button 520 to block or allow the moving course of the first and second operation buttons 510 and 520 as dictated by its rotation. A part of the rotating block 610 is protruded outside the body case 115 through a hole formed in the body case 115. The rotating block 610 protruded outside the body case 115 is configured to rotate while making contact with the combination block 125 provided on the display portion 120.

Hereinafter, operations and effects according to the fourth embodiment of the present invention will be described below.

The fourth embodiment works differently with respect to the display portion 120 being opened or closed. First, the case when the display portion 120 is closed will be described below with reference to FIGS. 12 and 13.

A user presses the pressing portion 511 of the first operation button 510 to open the first keyboard portion as necessary. At this time, the combination block 125 of the display portion 120 and the rotating block 610 provided on the body portion 110 are spaced apart at a certain interval. In this case, like the first embodiment, while the operation button 510 is being pressed, the protrusion 432 hooked by the first hook 514 of the operation button 510 is released and the first moving guide 430 moves by an elastic force of the first elastic body 440. As the first moving guide 430 moves, the first keyboard portion attached thereto also moves to be opened to the outside of the body portion 110. The first moving guide 430 moves to the end portion of the first guide groove 435, and the first keyboard portion connected thereto is also opened. In this manner, a user can use an auxiliary keypad provided on the first keyboard portion.

To close the first keyboard portion as necessary, the user pushes the first keyboard portion toward the body portion 110 to close the first keyboard portion, which is also the same as the first embodiment. At this time, the first moving guide 430 connected to the first keyboard portion moves, and the protrusion 432 formed on the end of the first moving guide 430 goes over the first hook 514 since the outer surface shape of the first hook 514 is inclined. Accordingly, the protrusion 432 of the first moving guide 430 is locked in place again via the first hook 514, and the first keyboard portion connected to the first moving guide 430 is closed and concealed by the body portion 110. At this time, the vertical extension portion 512 of the operation button 510 is provided with an elastic spring 516 in the body case 115, which enables the operation button 510 to be re-protruded to the outside.

Also, the user presses the second operation button 520 to open the second keyboard portion, and the procedures thereof are the same to those of the first operation button 510 and also, the procedures of closing the second keyboard portion are the same to those of the first keyboard portion. Also, the user may select and open either the first or the second keyboard portion having the auxiliary keypad the user wants to use. The user may also press both the first operation button 510 and the second operation button 520, thereby drawing both the first and the second keyboard portions.

Next, the case in which the display portion 120 slides to be opened will be described below with reference to FIGS. 14 and 15.

While the display portion 120 slides forward, the combination block 125 provided on the display portion 120 makes contact with the rotating block 610 provided on the body portion 110. The combination block 125 pushes the rotating block 610 to rotate within the range of about 20° to 90° around the axial projection 611. The rotating block 610 rotates to be disposed between the first operation button 510 and the second operation button 520. In this state, the user may press the first operation button 510, but the first operation button 510 is making contact with the rotating block 610. Thus, the first operation button 510 does not move. Namely, the first hook 514 of the first operation button 510 does not move to release the protrusion 432 of the first moving guide 430 and thus, the first keyboard portion is not opened. Similarly, the user may press the second operation button 520, but the second operation button 520 is making contact with the rotating block 610. Thus, the second operation button 520 does not move and the second keyboard portion 220 is not opened.

Accordingly, in the case a display portion is closed, a user may use an auxiliary keypad to create a text message, as necessary. Thus, the effectiveness in creating a text message may be improved. Also, in case of not using an auxiliary keypad, the auxiliary keypad may be concealed. Thus, when a user makes a call, the call is not interfered with. Also, the mobile terminal is aesthetically pleasing and is easy to use since it is possible to open and close an auxiliary keypad. Furthermore, in case of opening the display portion to make a call, although the user may inadvertently or intentionally press an operation button, the auxiliary keypad is not opened. Thus, the user can make a call without interference.

As described above, in the present embodiment, the rotating block 610 may be constructed to be disposed between the first operation button 510 and the second operation button 520, thereby binding the first and second operation buttons 510 and 520 simultaneously when the rotating block 610 rotates. In contrast to this, the rotating block 610 may also be constructed to bind only the first operation button 510 and not bind the second operation button 520 when the rotating block 610 rotates. In this way, even when the display portion 120 is opened, the second keyboard portion may be configured to be opened via the second operation button 520. This method is constructed to provide a necessary auxiliary keyboard to the second keyboard portion in the case a user opens the display portion 120 for its use, such as making a call, thereby enabling the second keyboard portion to be open by using the second operation button 520 even when the display portion 120 is open.

According to the present embodiment, since a user can be provided with an auxiliary keypad as necessary for creating a text message, the effectiveness in creating a text message can be improved.

Also, in the case an auxiliary keypad is not used, an auxiliary keypad can be concealed. Thus, when a user makes a call, the user can make a call without interference. Also, a mobile terminal is aesthetically pleasing and is easy to use since the auxiliary keypad can be closed and concealed by the body portion 110.

Also, since game keys can be provided through an auxiliary keypad, a user can have more fun playing a game.

Also, in the case a user opens a display portion to make a call, although the user may inadvertently or intentionally press an operation button, an auxiliary keypad is not opened. Thus, the call is not interfered with.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mobile terminal comprising:
a terminal body;
a display portion movably mounted on the terminal body; and
a keyboard portion provided to be slidable on the bottom of the terminal body and selectively exposing an auxiliary keypad.

2. The mobile terminal of claim 1, wherein the keyboard portion comprises:
a first keyboard portion attached on the bottom of the body and sliding to be opened in one direction; and
a second keyboard portion attached on the bottom of the body and sliding to be opened in an opposite direction from the direction in which the first keyboard portion is opened.

3. The mobile terminal of claim 1, wherein the terminal body comprises:
a body portion; and
a display portion slidably provided on the body portion and having a display for displaying visual information.

4. The mobile terminal of claim 3, wherein the display portion slides in the lengthwise direction of the body portion.

5. The mobile terminal of claim 3, wherein the display portion horizontally slides in the widthwise direction of the body portion.

6. The mobile terminal of claim 1, further comprising an operating unit which automatically opens the keyboard portion included in the terminal body via an operation button.

7. The mobile terminal of claim 6, wherein the operating unit comprises:
an operation button disposed on one side of the terminal body to enable a user to press;
a moving guide attached to the auxiliary keyboard portion to be movable in accordance with the pushing of the operation button;
a guide groove concavely formed on the rear of the terminal body to guide the moving guide; and
an elastic body connected to the moving guide to move the same by an elastic force.

8. The mobile terminal of claim 7, wherein the operation button is T-shaped, comprising:
a pressing portion;
a vertical extension portion transmitting movement of the pressing portion to the inside of a body case; and
a hook formed integrated with the vertical extension portion to selectively hook or release the moving guide in correspondence with movement of the pressing portion.

9. The mobile terminal of claim 8, further comprising an elastic spring which is mounted on the vertical extension portion and has the force of restitution to the outward direction of the body case.

10. The mobile terminal of claim 8, wherein the outside surface of the hook is inclined.

11. The mobile terminal of claim 7, wherein the moving guide is formed rectilinearly and an anchor portion, to which the elastic body is attached, is formed on one end of the moving guide and a protrusion, to be hooked by the hook of the operation button, is formed on the other end of the moving guide.

12. The mobile terminal of claim 11, wherein one end of the elastic body is attached to an anchor projection formed on the bottom of the terminal body and the other end thereof is attached to the anchor portion of the moving guide.

13. The mobile terminal of claim 12, wherein the elastic body is a torsion spring.

14. The mobile terminal of claim 7, wherein the elastic body is a tension spring which is disposed along the guide groove and of which one end is attached to the moving guide and the other end is attached to a projection formed on the end of the guide groove.

15. A mobile terminal comprising:
a body portion;
a display portion mounted on the body portion and having a display;
a keyboard portion provided to be slidable on the bottom of the body portion and selectively exposing an auxiliary keypad; and
an operating unit attached to the body portion and enabling the keyboard portion to be opened via an operation button, but, when the display portion is opened, preventing the opening of the keyboard portion even in the case the operation button is pressed.

16. The mobile terminal of claim 15, wherein the keyboard portion comprises:
a first keyboard portion attached on the bottom of the body and sliding to be opened in one direction; and
a second keyboard portion attached on the bottom of the body and sliding to be opened in an opposite direction to the direction in which the first keyboard portion is opened.

17. The mobile terminal of claim 15, wherein the auxiliary keypad comprises:
a first auxiliary keypad provided on the first keyboard portion; and
a second auxiliary keypad provided on the second keyboard portion.

18. The mobile terminal of claim 15, wherein the display portion slides in the lengthwise direction of the body portion.

19. The mobile terminal of claim 15, wherein the display portion horizontally slides in the widthwise direction of the body portion.

20. The mobile terminal of claim 15, wherein the operating unit comprises:
an operation button disposed on one side of the body portion to enable a user to press;
a moving guide attached to the keyboard portion to be movable in accordance with the pushing of the operation button;
a guide groove concavely formed on the rear of the terminal body to guide the moving guide;
an elastic body connected to the moving guide to move the same by an elastic force;
a rotating block rotatably protruded on the lower part of the body portion; and
a combination block protruded on the lower part of the display portion and rotating the rotating block in the case the display portion is open and maintaining a certain interval with the rotating block in the case the display portion is closed.

21. The mobile terminal of claim 20, wherein the operation button is “T”-shaped, comprising:
a pressing portion;
a vertical extension portion transmitting movement of the pressing portion to the inside of a body case;
a hook formed integrated with the vertical extension portion to selectively hooked or released the moving guide in correspondence with movement of the pressing portion; and
a braking portion formed on the vertical extension portion and extending to be formed on one end opposite to the pressing portion.

22. The mobile terminal of claim 21, further comprising an elastic spring which is mounted on the vertical extension portion and has the force of restitution to the outward direction of the body case.

23. The mobile terminal of claim 21, wherein the outside surface of the hook is inclined.

24. The mobile terminal of claim 20, wherein the moving guide is formed rectilinearly and an anchor portion to which the elastic body is attached is formed on one end of the moving guide and a protrusion hooked by the hook of the operation button is formed on the other end of the moving guide.

25. The mobile terminal of claim 24, wherein one end of the elastic body is attached to an anchoring projection formed on the bottom of the terminal body and the other end of the elastic body is attached to the anchor portion of the moving guide.

26. The mobile terminal of claim 25, wherein the elastic body is a torsion spring.

27. The mobile terminal of claim 20, wherein the elastic body is an elastic spring which is disposed along the guide groove and of which one end is connected to the moving guide and the other end is attached to a projection formed on the other end of the guide groove.

28. The mobile terminal of claim 20, wherein the rotating block is in the shape of a hexahedron and constructed to be rotatable around the axial projections which are formed on both its sides.

29. The mobile terminal of claim 28, wherein a part of the rotating block is protruded outside the body case through a hole formed in the body case.

30. The mobile terminal of claim 20, wherein the rotating block rotates to be in contact with the combination block in the case the display portion is open, thereby stopping movement of the operation button, and does not interfere with the movement of the operation button in the case the display portion is closed.
